(19) United States
(12) Patent Application Publication
(10) Pub. No.: US 2014/0175077 A1
(43) Pub. Date: Jun. 26, 2014

(54) ELECTRONICALLY INDUCED CERAMIC FUSIBLE METAL SYSTEM

(71) Applicant: Raytheon Company, (US)

(72) Inventors: Jeremy B. Baldwin, Tucson, AZ (US); Kevin W. Patrick, Tucson, AZ (US); Michael D. Gordon, Tucson, AZ (US); Timothy Mobley, Marana, AZ (US)

(73) Assignee: Raytheon Company, Waltham, MA (US)

(21) Appl. No.: 13/724,686

(22) Filed: Dec. 21, 2012

(51) Int. Cl. B23K 11/30

(52) U.S. Cl. CPC B23K 11/30
USPC 219/148

(57) ABSTRACT

An electrically induced fusing system includes a module having walls and a base to define a module body. The module body includes first and second conductive layers stacked next to one another. An electrically resistive layer is interposed between the first and second conductive layers, and is configured to emit heat in response to receiving electrical current from a power supply. At least one electrically conductive terminal is in electrical communication with the resistive layer and an output of the power supply to form an electrical path that delivers the current to the resistive layer. The system further includes a separable component configured to attach to the first conductive layer. At least one fusing element is interposed between the separable component and the first conductive layer, and is configured to melt in response to the heat emitted by the resistive layer.

### BACKGROUND

The present disclosure relates generally to fabricating component housings and, more particularly, to an electronically induced fusing system to fabricate components.

Conventional brazing methods for fixing electrical components tend to excessively heat large portions of a module containing the electrical components. These electrical components may be thermally sensitive, and can be damaged when exposed to the excessive heat generated by the conventional brazing methods.

In addition, it is desirable to provide a lid that covers the electrical components disposed within the module. Conventional methods of using solder or a brazing compound to attach the lid include placing the module and lid together in a heated oven to melt the solder or brazing compound. The oven, however, excessively heats the entire module, which can damage thermally sensitive electrical components.

### SUMMARY

In an exemplary embodiment, an electrically induced fusing system comprises a module including walls and a base to define a module body. The module body includes first and second conductive layers stacked next to one another. An electrically resistive layer is interposed between the first and second conductive layers, and is configured to emit heat in response to receiving electrical current from a power supply. At least one electrically conductive terminal is in electrical communication with the resistive layer and an output of the power supply to form an electrical path that delivers the current to the resistive layer. The system further includes a separable component configured to attach to the first conductive layer. At least one fusing element is interposed between the separable component and the first conductive layer, and is configured to melt in response to the heat emitted by the resistive layer.

In another embodiment, a fusible module comprises a base and walls extending perpendicular from the base. The walls extend along a length and width to define a module body. The module body comprises a plurality of conductive layers stacked against one another. The plurality of conductive layers includes a resistive layer interposed between a first conductive layer and a second conductive layer. The resistive layer is formed from an electrically resistive material that emits heat in response to electrical current flowing therethrough. At least one fusing element is disposed adjacent the resistive layer. The at least one fusing element is configured to melt in response to the heat emitted from the resistive layer to form at least one melted fusing element.

In yet another embodiment, a method of electronically fusing a separable component to a module body comprises interposing an electrically resistive layer between first and second conductive layers integrated in the module body. The method further includes disposing at least one fusing element against at least one of the module body and the separable component. The at least one fusing element is configured to melt in response to heat. The method further includes generating an electrical current, and flowing the current through the resistive layer to generate heat such that the fusing element melts and the module body bonds to the separable component.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a block diagram illustrating an electrically induced fusing system to fuse a module according to an embodiment;

FIG. 2 is a top view of the module illustrated in FIG. 1;

FIGS. 3A-3F, are a series of block diagrams illustrating a process flow of an electrically induced fusing process, where:

FIG. 3A illustrates a fusing module including a housing unit and cover existing in a separated state;

FIG. 3B illustrates the cover shown in FIG. 3A following the coupling of solder balls;

FIG. 3C is a bottom view of the cover illustrated in FIG. 3B;

FIG. 3D illustrates the fusing module shown in FIG. 3B after placing the cover on an upper surface of the housing unit;

FIG. 3E illustrates melted solder balls in response to connecting a power source to the cover shown in FIG. 3D; and

FIG. 3F illustrates the fusing module shown in FIG. 3E existing in a fused state after the melted solder balls have been cooled.

FIG. 4 is block diagram illustrating a fusible module including an integrated heating element according to an embodiment;

FIG. 5 is a block diagram illustrating a fusible module including an integrated heating element according to another embodiment; and

FIG. 6 is a block diagram illustrating a fusible module including an electrical component coupled to a flat base of a housing unit according to another embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature(s) being described. Also, the description is not to be considered as limiting the scope of the embodiments described herein.

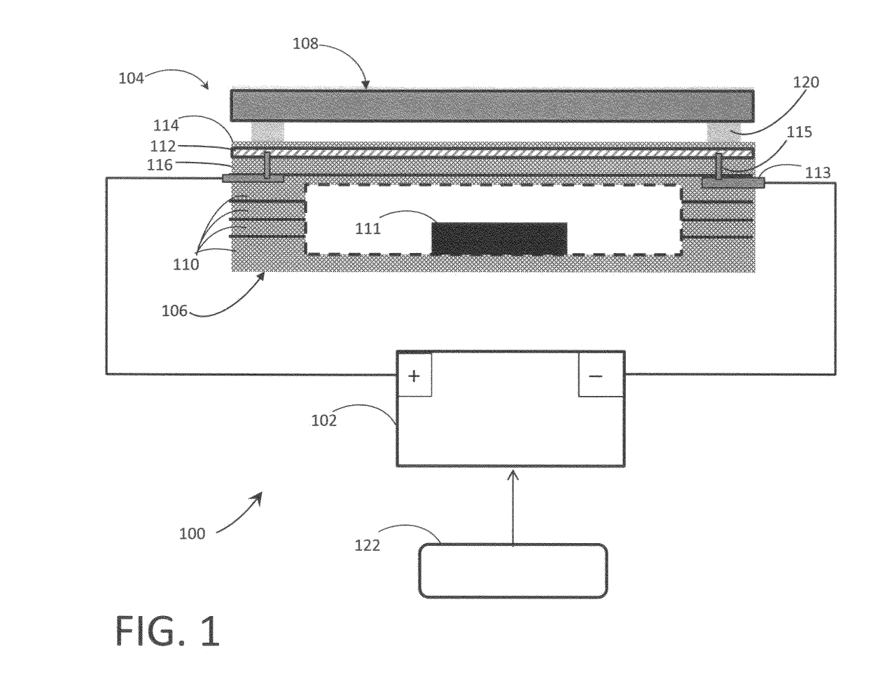

Referring now to FIG. 1, a block diagram illustrates an electrically induced fusing system 100 according to an embodiment. The fusing system 100 comprises a power supply 102 configured to supply electrical current to a module 104. The power supply 102 may comprise a variable power supply that generates electrical current at a plurality of different current levels.

The module 104 includes a module body 106 and a separable component 108. The module body 106 may be formed as a housing that contains a plurality of conductive layers 110 as further illustrated in FIG. 1. One or more electrical components 111 may be coupled to one or more conductive layers 110. For example, the conductive layer 110 may be formed as a printed circuit board (PCB) (not shown) having one or more electrical components formed thereon. The module body 106 may be formed from various electrical insulating materials including, but not limited to, ceramic, polytetrafluoroethylene (PTFE, i.e., Teflon®), and glass epoxy laminates such as FR-4.

The module body 106 further includes at least one resistive layer 112 integrated therein and interposed between a first conductive layer 114 and a second conductive layer 116. The resistive layer 112 is formed from an electrically resistive material that emits heat in response to electrical current flowing therethrough. For example, the resistive layer 112 may be formed from copper, silver, tantalum nitride (TaN), nichrome, gold, etc. The resistive layer 112 is integrated in the module body 106 and defines a localized heating area 118 at the first conductive layer 114. Further, the resistive layer 112 may have a width of about 0.2 millimeters (mm) to about 0.5 mm. The resistive layer may be disposed near the upper surface of the first conductive layer 114. For example, the distance between the upper surface of the first conductive layer 114 and the resistive layer may range from about 0.08 mm to about 0.24 mm.

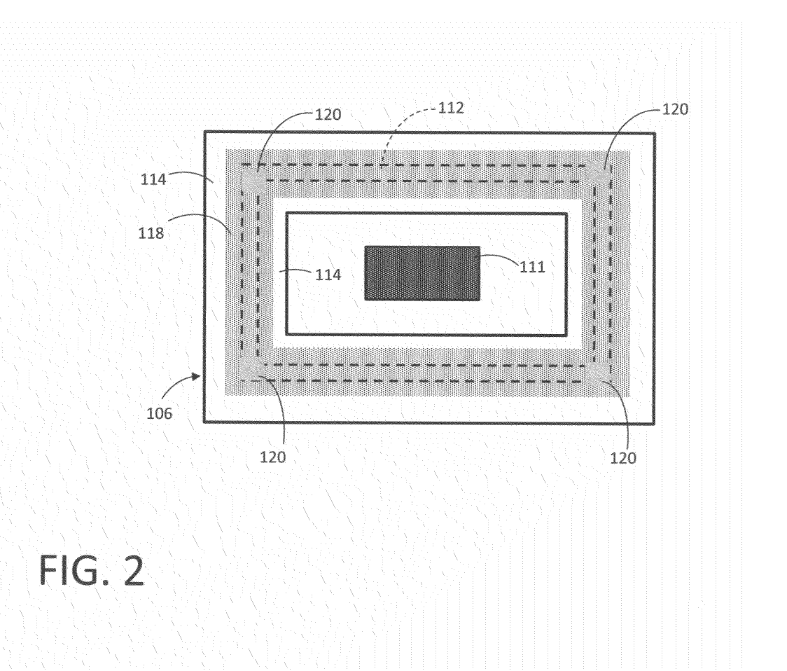

Referring to FIG. 2, for example, a top view of the module body 106 is illustrated. The resistive layer 112 defines the localized heating area 118 at an upper surface of the first conductive layer 114. Accordingly, the resistive layer is embedded beneath the first conductive layer 114 in a particular manner such that heat from the resistive layer 112 is localized, i.e., realized at particular heating areas of the first conductive layer 114. One or more fusing elements 120 may be disposed at the localized heating area 118, as discussed in greater detail below. As a result, remaining portions of the module 104 may be excluded from becoming heated.

Referring again to FIG. 1, at least one electrically conductive terminal is in electrical communication with the resistive layer 112 and an output of the power supply 102. For example, a power terminal 113 and a ground terminal 113′ may be connected to the resistive layer 112. In at least one embodiment illustrated in FIG. 1, the power 113 and ground terminals 113′ are disposed at a layer different from the resistive layer 112. One or more electrically conductive vias 115 may extend between one or more intervening layers to contact the terminals 113 to the resistive layer 112.

The separable component 108 may be a component to be attached and detached to and from the module body 106. For example, the separable component 108 may be formed as a cover as further illustrated in FIG. 1. The separable component 108 may be formed from various electrical insulating materials including, but not limited to, ceramic, polytetrafluoroethylene (PTFE, i.e., Teflon®), and glass epoxy laminates such as FR-4.

Referring further to FIG. 1, one or more fusing elements 120, such as solder balls, are interposed between the separable component 108 and first conductive layer 114, and are disposed at the localized heating area 118 to receive the heat emitted resistive layer 112. Although solder balls are described in FIG. 1, the fusing element 120 may be formed from, for example, a brazing compound, an epoxy, or a metal-epoxy compound. In response to the heat emitted by the resistive layer 112, the fusing element 120 melts such that the separable component 108 bonds to the first conductive layer 114. The separable component 108 and first conductive layer 114 remains fixed to together after the melted fusing element is cooled and hardened.

The fusing system 100 may further include a microcontroller 122 in electrical communication with the power supply 102. The microcontroller 122 is configured to store a predetermined thermal profile that models thermal behavior over a time period. One example of a thermal model is a Ramp-Soak-Spike (RSS) profile. Accordingly, the microcontroller 122 may adjust the power supply 102 to vary a current level of the current based on the thermal model such that thermal levels realized by the fusing element 120 may be controlled.

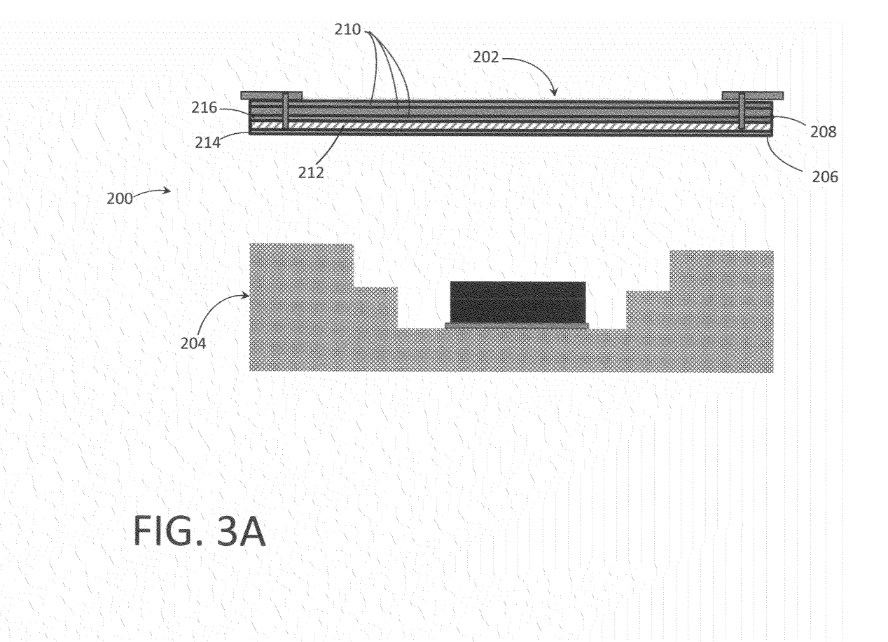

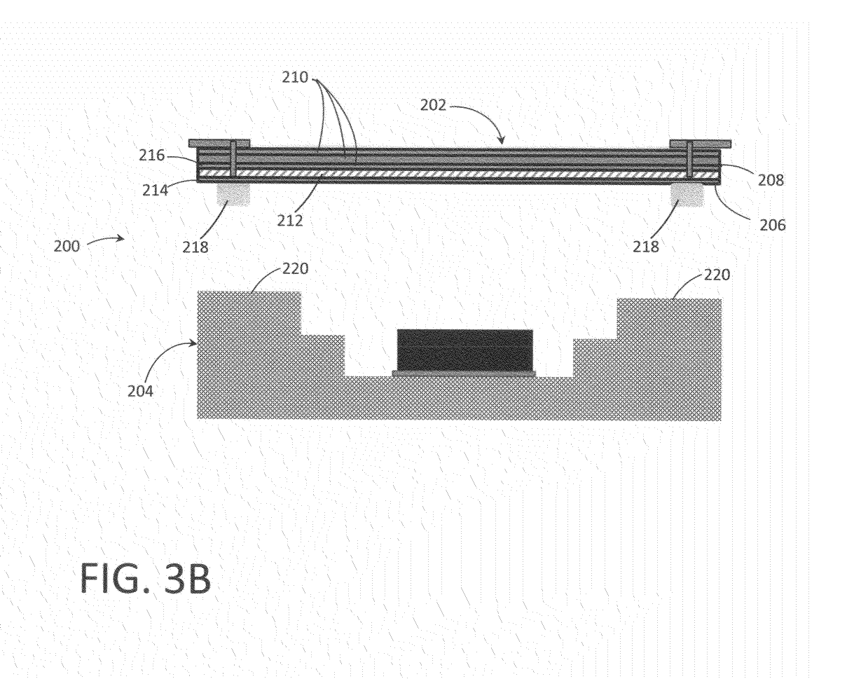

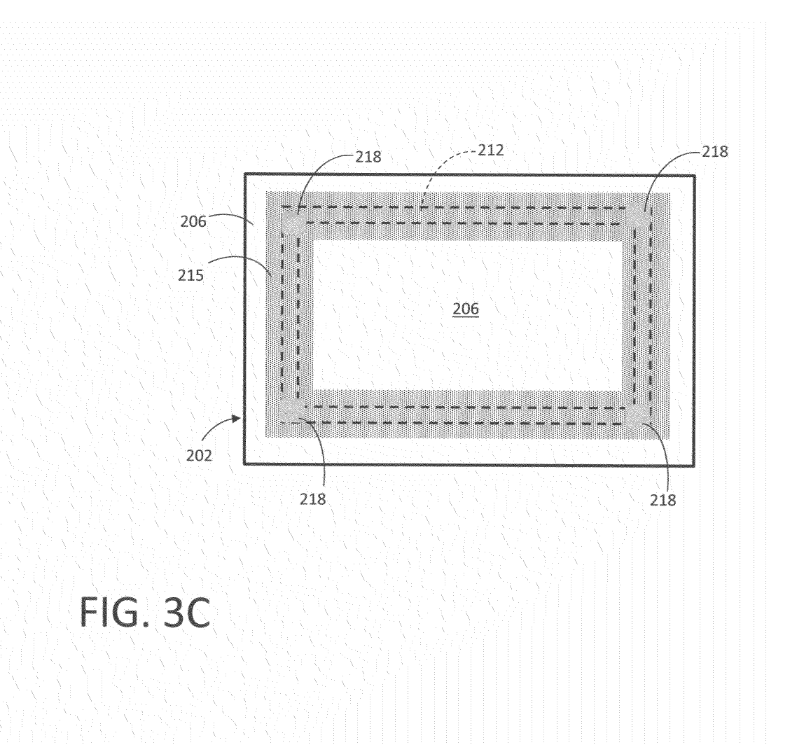

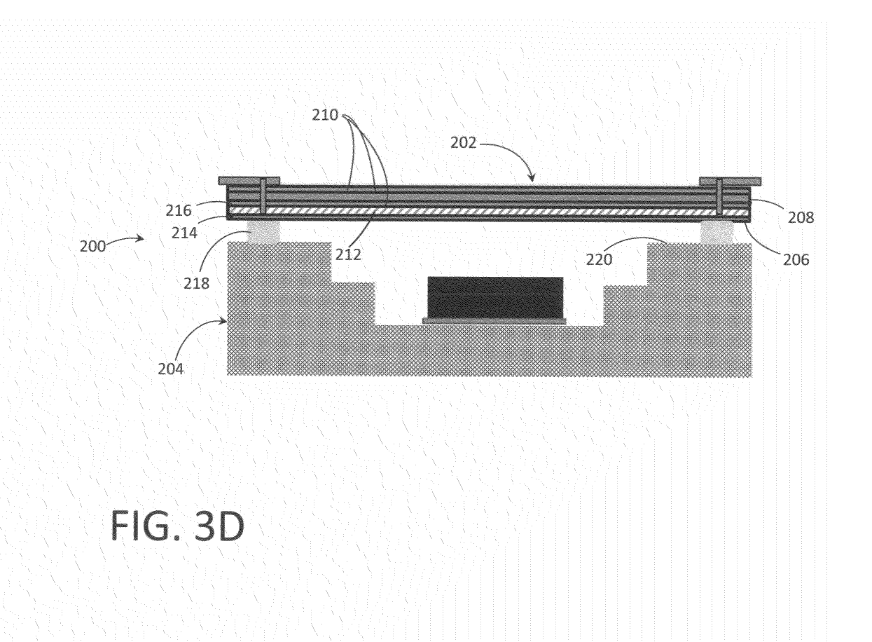

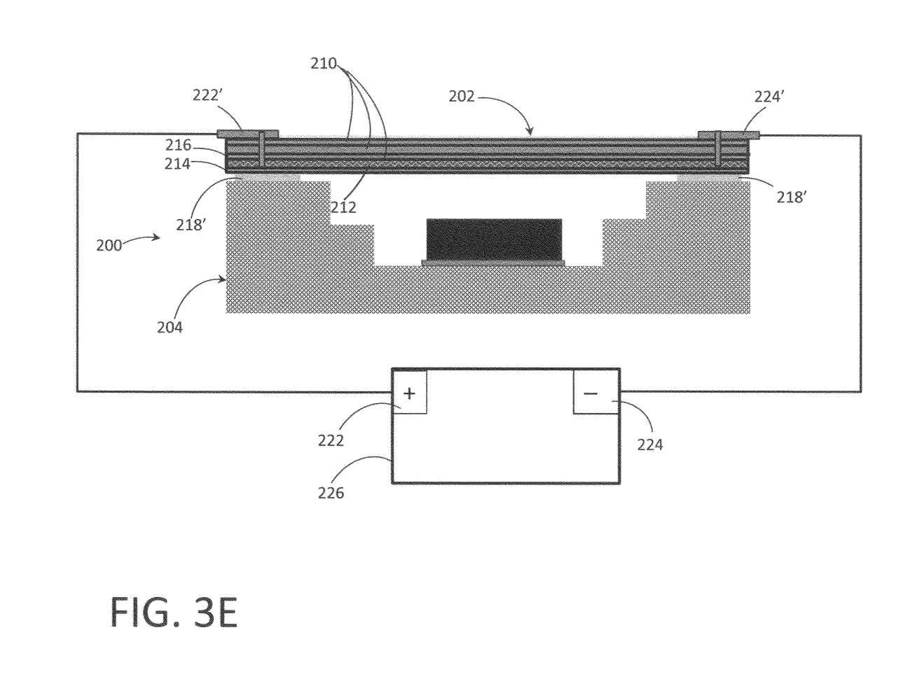

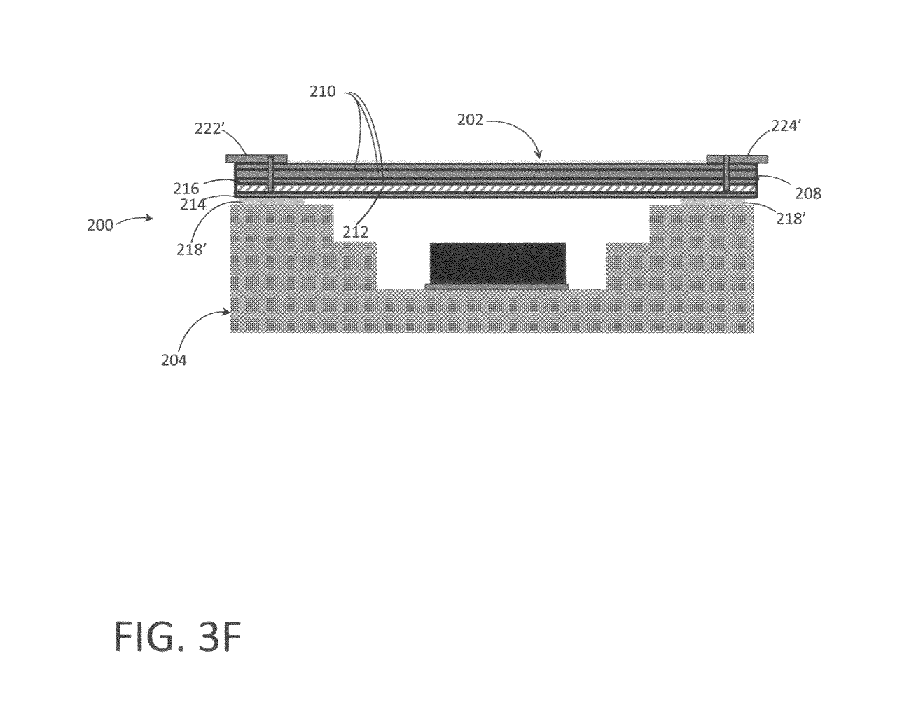

Referring now to FIGS. 3A-3F, a process flow of an electrically induced fusing process is illustrated according to an embodiment of the disclosure. Referring to FIG. 3A, a fusing module 200 existing in a separated state is illustrated. The fusing module 200 includes a module body, such as a housing unit 204, and a separable portion, such as a cover 202. Although FIGS. 3A-3F illustrate the module body as a housing unit 204 and the separable portion as a cover 202, it is appreciated that the module body may be formed as the housing unit and the separable portion may be formed as the cover. The cover 202 and the housing unit 204 may be formed from an electrical insulating material, such as ceramic.

The cover 202 includes a base 206 extending along a first direction to define a length and a second direction to define a width. Walls 208 extend perpendicular from the base 206 to define an exterior of the cover 202. The cover 202 comprises a plurality of layers 210 stacked against one another. The plurality of layers 210 include a resistive layer 212 interposed between a first conductive layer 214 and a second conductive layer 216. The resistive layer 212 is formed from an electrically resistive material, such as copper, silver, tantalum nitride (TaN), nichrome, gold, etc., that emits heat in response to electrical current flowing therethrough.

Referring to FIG. 3B, fusing elements, such as solder balls 218, are disposed at a lower surface, i.e., the base 206, of the cover 202. As discussed above, the resistive layer 212 defines a localized heating area 215 at the first conductive layer 214. A bottom view of the cover 202 is illustrated in FIG. 3C, shows the resistive layer 212 embedded in the cover 202 to define the localized heating area 215. Accordingly, the solder balls 218 are disposed at the localized heating area 215 located at the lower surface, i.e., base 206, of the cover 202.

Turning now to FIG. 3D, the cover 202 is disposed against an upper surface 220 of the housing unit 204 such that the solder balls 218 are located therebetween. As discussed above, the solder balls 218 melt in response to the heat emitted from the resistive layer 212 to form a melted fusing element 218′.

Referring to FIG. 3E, a power output 222 and a ground output 224 from a power supply 226 are applied to power and ground terminals 222′, 224′, respectively, formed in the cover 202. The power generates electrical current flow through the resistive layer 212. As discussed above, the current heats the resistive layer 212 and heat emitted therefrom melts the solder balls 218. When the melted fusing elements 218′ harden, for example by being cooled, the cover 202 is bonded to the housing unit 204 as illustrated in FIG. 3F.

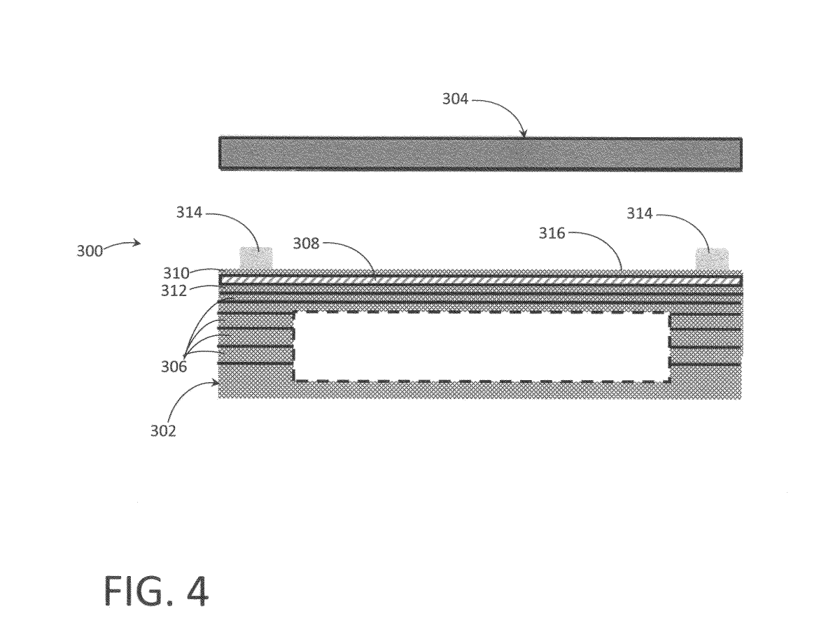

Turning now to FIG. 4, a fusing module 300 is illustrated according to another embodiment. The fusing module 300 of FIG. 3 is similar to the fusing module 200 illustrated in FIGS. 3A-3F. However, the module body is formed as a housing unit 302 and the separable portion is formed as the cover 304. Accordingly, instead of integrating a resistive layer in the cover 304, the resistive layer is integrated in the housing unit 302.

More specifically, the housing unit 302 includes a plurality of conductive layers 306 stacked against one another. A resistive layer 308 is interposed between a first conductive layer 310 and a second conductive layer 312. The resistive layer 308 is formed from an electrically resistive material, such as copper, silver, tantalum nitride (TaN), nichrome, gold, etc., that emits heat in response to electrical current flowing therethrough.

Fusing elements, such as solder balls 314, are disposed at an upper surface 316 of the first conductive layer 310. As discussed above, the resistive layer 308 is integrated in the housing unit 302 such that a localized heating area may be defined at the upper surface 316 of the first conductive layer 310. The solder balls 314 are disposed at the localized heating areas, and the cover 304 is disposed against the upper surface 316 of the first conducting layer 310. Accordingly, the solder balls 314 are disposed between the cover 304 and the first conductive surface 310 of the housing unit 302. As discussed above, the solder balls 314 melt in response to current-induced heat emitted from the resistive layer 308 to form a melted fusing element such that the cover 304 is bonded to the housing unit 302.

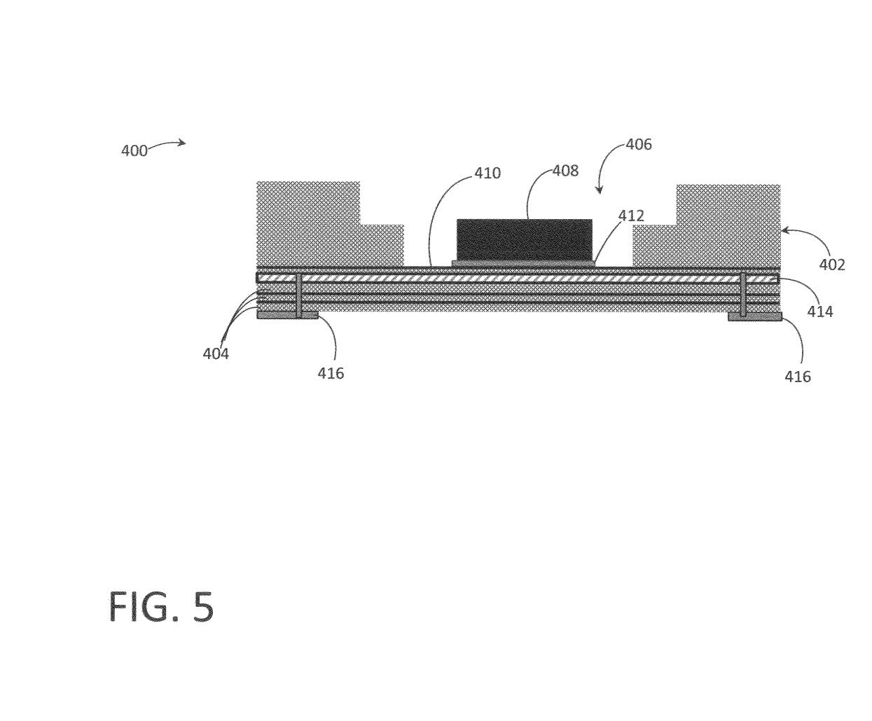

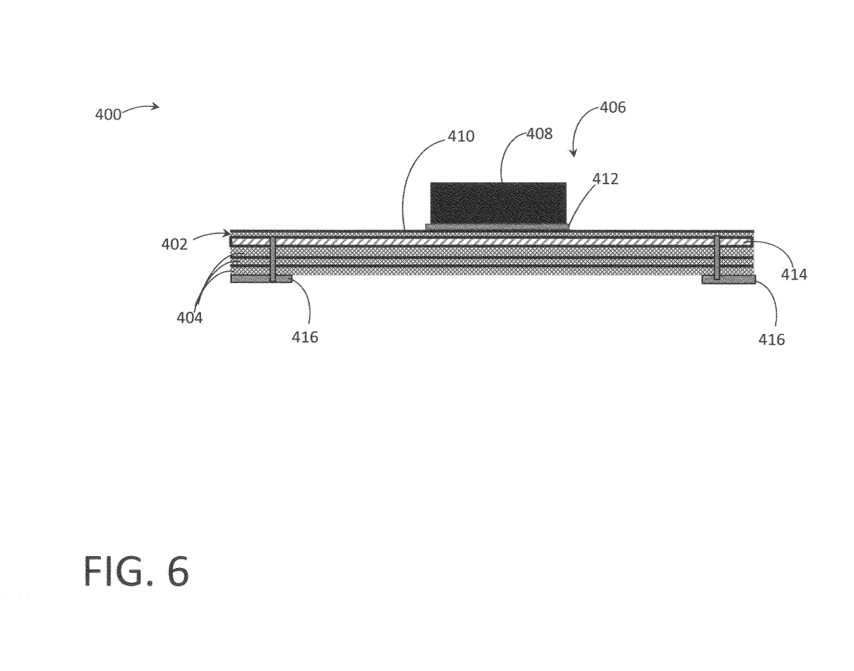

Referring now FIG. 5, another embodiment of a fusing module 400 is illustrated. The fusing module 400 includes a housing unit 402 having a plurality of conductive layers 404 stacked against one another. A void 406 may be formed in the conductive layers 404 such that an electrical component 408 may be fitted against a base 410 within the housing unit 402. In at least one embodiment, the base 410 includes a fusing element, such as solder pad 412, formed thereon to receive the electrical component 408. In this case, therefore, the module body is formed as the housing unit 402 and the separable component is formed as the electrical component 408. Referring to FIG. 6, at least one embodiment illustrates the electrical component 408 coupled to a flat base of the housing unit 402.

The housing unit 402 includes a resistive layer 414 integrated therein. More specifically, the resistive layer 414 is disposed beneath the base 410 that supports the electrical component 408. The housing unit 402 may include one or more electrical terminals 416, which are configured to receive an electrical output generated from a power supply. As described above, the resistive layer 414 is formed from an electrically resistive material, such as copper, silver, tantalum nitride (TaN), nichrome, gold, etc., that emits heat in response to electrical current flowing therethrough. Accordingly, the heat emitted from the resistive layer 414 melts the solder pad 412, thereby bonding the electrical component 408 to the base 410. Although not illustrated, an electrical component 408 and a cover may both be bonded to the housing unit 402 using the electrically induced fusing method described in detail above.

In each of the embodiments described above, it is appreciated that electrical power may be re-applied to the resistive layer while the fusing module exists in the fused state. As a result, the fusing element may again be melted and the module body and separable portion may be separate from another without exposing the entire fusing module to excessive heat.

As will thus be appreciated, among the technical benefits of the above described embodiments is a feature of providing a localized thermal area such that sensitive components included in the fusing module are not subjected to excessive temperatures. Accordingly, thermal damage to sensitive electrical components may be prevented.

While the disclosure has been described with reference to a preferred embodiment or embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. An electrically induced fusing system, comprising:
a power supply configured to generate an electrical current;
a module including walls extending perpendicular from a base and extending along a length and a width to define a module body, the module body comprising:
first and second conductive layers stacked next to one another;
a resistive layer interposed between the first and second conductive layers, the resistive layer formed from an electrically resistive material that emits heat in response to electrical current flowing therethrough; and
at least one electrically conductive terminal in electrical communication with the resistive layer and an output of the power supply, the electrically conductive terminal configured to form an electrical path to deliver the current to the resistive layer;
a separable component to attach to the first conductive layer; and
at least one fusing element interposed between the separable component and the first conductive layer.

2. The system of claim 1, wherein the resistive layer defines a localized heating area at the first conductive layer, and the at least one fusing element is disposed at the localized heating area.

3. The system of claim 2, wherein the at least one fusible metal melts in response to the heat emitted by the resistive layer such that the separable component bonds to the first conductive layer.

4. The system of claim 3, further comprising a microcontroller in electrical communication with the power supply, the microcontroller configured to store a predetermined thermal model that models thermal behavior with respect to a time period.

5. The system of claim 4, wherein the microcontroller controls the power supply based on the thermal model to vary a current level of the current.

6. The system of claim 5, wherein the thermal model is a Ramp-Soak-Spike (RSS) profile.

7. The system of claim 3, wherein the module body and the separable component are formed from ceramic and the at least one fusing element is formed from solder.

8. A fusible module, comprising:
a base and walls extending perpendicular from the base, the walls extending along a length and width to define a module body;
the module body comprising a plurality of conductive layers stacked against one another, the plurality of conductive layers including a resistive layer interposed between a first conductive layer and a second conductive layer, the resistive layer formed from an electrically resistive material that emits heat in response to electrical current flowing therethrough; and
at least one fusing element disposed adjacent the resistive layer, the at least one fusing element configured to melt in response to the heat emitted from the resistive layer to form at least one melted fusing element.

9. The fusible module of claim 8, wherein the resistive layer defines a localized heating area at the first conductive layer, and the at least one fusing element is disposed at the localized heating area.

10. The fusible module of claim 9, further comprising at least one electrical terminal configured to electrically communicate with the power source to supply the electrical current.

11. The fusible module of claim 10, further comprising a separable component configured to bond to the first conductive layer via the at least one melted fusing element.

12. The fusible module of claim 11, wherein the at least one fusing element is formed on at least one of the first conductive layer and the separable component.

13. The fusible module of claim 12, wherein at least one of the module body and the separable component are formed from ceramic, the at least one fusing element is formed from solder, and the resistive material is formed from copper.

14. The fusible module of claim 12, wherein the module body is a ceramic housing containing at least one electrical component and the separable component is a ceramic cover that couples to the ceramic housing via the at least one melted fusing element to cover the at least one electrical component.

15. The fusible module of claim 12, wherein the module body is a ceramic cover and the separable component is a ceramic housing containing at least one electrical component, the ceramic cover being coupled to the ceramic housing via the at least one melted fusing element to cover the at least one electrical component.

16. The fusible module of claim 12, wherein the module body is a ceramic housing and the separable component is an electrical component that bonds to the first conductive layer via the at least one melted fusing element.

17. A method of electronically fusing a separable component to a module body, the method comprising:
interposing an electrically resistive layer between first and second conductive layers integrated in the module body;
disposing at least one fusing element to at least one of the module body and the separable component, the at least one fusing element configured to melt in response to heat;
generating an electrical current; and
flowing the electrical current through the resistive layer to generate heat such that the fusing element melts and the module body bonds to the separable component.

18. The method of claim 17, wherein the disposing at least one fusing element further comprises disposing at least one fusing element at a localized heating area of the first conductive layer defined by the resistive layer.

19. The method of claim 18, wherein the flowing the electrical current further comprises varying a current level of the electrical current based on a thermal model.

20. The method of claim 19, wherein the thermal model is a Ramp-Soak-Spike (RSS) profile.
